(19) United States
(12) Patent Application Publication
(10) Pub. No.: US 2020/0165904 A1
(43) Pub. Date: May 28, 2020

(54) VEHICLE, METHOD, AND SYSTEM FOR WASTE MATERIALS

(71) Applicant: METAFLO TECHNOLOGIES INC., Toronto (CA)

(72) Inventors: Andrew MCNABB, Toronto (CA); XIAN MENG HUANG, Ottawa (CA); Nolan PIETTE, Mississauga (CA)

(21) Appl. No.: 16/610,795

(22) PCT Filed: May 3, 2018
(86) PCT No.: PCT/IB2018/053094

§ 371 Date: Nov. 4, 2019

Related U.S. Application Data
(60) Provisional application No. 62/501,361, filed on May 4, 2017.

(51) Int. Cl. E21B 41/00; E21B 21/06

(52) U.S. Cl. CPC E21B 41/005; B60P 3/2245; E21B 21/066

(57) ABSTRACT

A vehicle, method and system for removing waste material from a worksite is provided. An example of a vehicle includes a containment tank, a vacuum inlet pipe, a reagent tank, an injection point, and a deliver system to deliver the liquid-phase reagent to injection point. An example method includes drawing the waste material using a vacuum inlet pipe, delivering the liquid-phase reagent to the waste material, adding the liquid-phase reagent to the waste material and delivering the waste material to a containment tank. An example system includes a reagent tank and a delivery system to deliver the liquid-phase reagent to the liquid-phase reagent via a connector.

### CROSS-REFERENCE TO RELATED APPLICATIONS

This application claims the benefit of priority from U.S. Provisional Application No. 62/501,361, filed on May 4, 2017, the entire contents of which are hereby incorporated by reference herein.

### FIELD

The present specification relates generally to an apparatus, method, and reagent for solidifying a liquid, and more particularly to solidifying liquid waste.

### BACKGROUND

Liquid waste is generated in a wide variety of industries where removal and transportation of liquids can be difficult. For example, in drilling applications, such as in the oil and gas industry, large amounts of liquid waste are often generated at a work site. The liquid waste is commonly pumped into a holding pond or storage bin where the liquid waste can collect.

### SUMMARY

In accordance with an aspect of the invention, there is provided a vehicle for removing waste material from a worksite. The vehicle includes a containment tank to store the waste material. In addition, the vehicle includes a vacuum inlet pipe in communication with the containment tank. The vacuum inlet pipe is to draw the waste material from the worksite and to deliver the waste material to the containment tank. Furthermore, the vehicle includes a reagent tank to store a liquid-phase reagent. The liquid-phase reagent is a polymer suspension in an oil, the polymer to solidify the waste material. The vehicle also includes an injection point to receive the liquid-phase reagent, wherein the injection point provides access to the liquid waste. Additionally, the vehicle includes a delivery system to deliver the liquid-phase reagent to injection point.

In accordance with an aspect of the invention, there is provided a method of removing waste material from a worksite. The method involves drawing the waste material from the worksite via a vacuum inlet pipe. The method further involves delivering a liquid-phase reagent to an injection point, wherein the liquid-phase reagent is a polymer suspension in an oil, the polymer to solidify the waste material. In addition, the method involves adding the liquid-phase reagent to the waste material at the at the injection point to solidify the waste material. Furthermore, the method involves delivering the waste material to a containment tank. Additionally, the method involves storing the solidified waste material in the containment tank.

In accordance with an aspect of the invention, there is provided a system for solidifying waste material from a worksite. The system includes a liquid-phase reagent source to provide a liquid-phase reagent. The liquid-phase reagent is a polymer suspension in an oil, the polymer to solidify the waste material. The system also includes a delivery system to deliver the liquid-phase reagent to the waste material. In addition, the system includes a connector to connect the delivery system to waste removal system. The waste removal system is to collect the waste material

### BRIEF DESCRIPTION OF THE DRAWINGS

Reference will now be made, by way of example only, to the accompanying drawings in which:

FIG. 1 is a schematic view showing a boring operation according to an embodiment;

FIG. 2 is a schematic view showing an apparatus for solidifying a liquid waste according to an embodiment used in the operation shown in FIG. 1;

FIG. 3 is a schematic view showing a boring operation according to another embodiment;

FIG. 4 is a schematic view showing an apparatus for solidifying a liquid waste according to another embodiment used in the operation shown in FIG. 3;

FIGS. 5A-B are schematic views showing apparatus for solidifying a liquid waste according to other embodiments;

FIGS. 6A-B are schematic views showing apparatus for solidifying a liquid waste according to other embodiments;

FIGS. 7A-B are schematic views showing apparatus for solidifying a liquid waste according to other embodiments;

FIGS. 8A-B are schematic views showing apparatus for solidifying a liquid waste according to other embodiments;

FIG. 9 is a schematic view showing an apparatus for solidifying a liquid waste according to another embodiment;

FIG. 10 is a schematic view showing an apparatus for solidifying a liquid waste according to another embodiment;

FIG. 11 is a schematic view showing an operation for removing liquid waste from a holding pond;

FIGS. 12A-B are schematic views showing apparatus for solidifying a liquid waste according to other embodiments; and

FIG. 13 is a schematic view showing an apparatus for solidifying a liquid waste according to another embodiment.

### DETAILED DESCRIPTION OF THE EMBODIMENTS

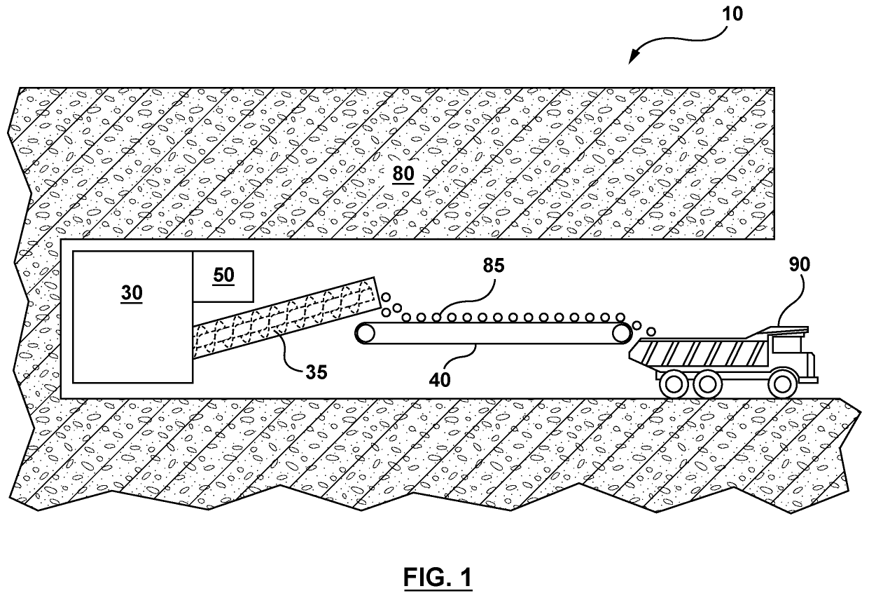

Referring to FIG. 1, a schematic representation of a tunnel boring operation is generally shown at 10. It is to be understood that the tunnel boring operation 10 is purely exemplary and that it will become apparent to those skilled in the art that modifications to the operation 10 are contemplated. In the present embodiment, the tunnel boring operation 10 includes a tunnel boring machine 30, an auger 35, a conveyor belt 40, and an apparatus 50 for solidifying a liquid waste.

In the present embodiment, the tunnel boring machine 30 is generally configured to excavate tunnels through earth 80. The tunnel boring machine 30 includes a cutting surface for cutting the earth 80. It is to be appreciated that the cuttings generated by the tunnel boring machine 30 fall to the bottom of the tunnel at the bore face along with liquids such as water and/or additives (such as oil, dispersants, and soil conditioners) used to lubricate and cool the cutting surface of the tunnel boring machine. In addition, water can be present in the earth 80 through which the tunnel boring machine 30 is drilling. The liquids and the cuttings can mix to generate liquid waste at the bore face that would need to be removed during the boring operation.

In the present embodiment, the auger 35 is generally configured to carry waste away from the cutting surface of the tunnel boring machine 30. The manner by which the auger 35 operates is not particularly limited. For example, waste generally collects near the bottom of the face of the tunnel boring machine 30. In the present embodiment, the auger 35 is configured to move waste that has been treated with a liquid-phase reagent from the apparatus 50 as discussed in further detail below. Accordingly, the auger 35 can be configured to move solid waste and/or liquid waste of various viscosities away from the tunnel boring machine 30 to the conveyor belt 40.

In the present embodiment, the conveyor belt 40 is generally configured to carry solid waste 85 further away from the tunnel boring machine 30 and ultimately out of the tunnel to a vehicle 90 for removal from the boring operation 10. It is to be appreciated by a person of skill in the art with the benefit of this description that the conveyor belt 40 is not limited and can be modified. For example, the conveyor belt 40 can include several parts or belt sections and be extended as the tunnel boring machine 30 advances into the earth 80. Furthermore, although the present embodiment shows a horizontal conveyor belt 40, it is to be appreciated that in some applications, the conveyor belt 40 can be inclined to reach the surface. In addition, instead of leading directly to the vehicle 90, the conveyor belt 40 may lead to a storage pit, tank, or other holding facility for subsequent removal.

The apparatus 50 for solidifying the liquid waste is generally configured to deliver a liquid-phase reagent proximate to the bore face in the present embodiment. The exact location where the liquid-phase reagent is delivered is not particularly limited and can be varied depending on the application as well as the specific manufacturer design of the boring equipment. For example, the liquid-phase reagent can be delivered via an injection port (not shown) near or at the end of auger 35. The manner by which the apparatus 50 operates is not particularly limited. In the present embodiment, the apparatus 50 is generally mounted on the tunnel boring machine 30 and configured to deliver the liquid-phase reagent to a location suitable for treating liquid waste generated at the cutting surface.

It is to be appreciated that the liquid-phase reagent is not particularly limited, and that various liquid-phase reagents can be substituted. The liquid-phase reagent is configured to react with the liquid, such as water mixtures, proximate to the cutting surface in order to cause solidification by converting a liquid into a solid through a chemical reaction or by binding the liquid within a solid. It is to be appreciated that by the term solid means that the product meets pre-determined physical properties capable of being handled in a more economic manner and that the exact minimum physical properties for being considered a solid is not particularly limited and can be varied depending on the application. For example, a paint filter test or a slump test can be applied to the solid to determine whether the solid has the desired physical properties, such as to meet regulatory solids criteria. The paint filter test involves testing whether the liquid within a sample will pass through a paint filter within a predetermined period of time. It is to be appreciated by a person of skill in the art that the exact type of filter and the length of the predetermined period of time is not particularly limited and can be varied to adjust the threshold for different applications. In the present embodiment, the paint filter can be a 60 mesh (250 micron) filter and the predetermined period of time is about five minutes. The slump test involves filling the solid material into a cone shaped mold, placing the open end of the mold on a surface (i.e. the ground), removing the mold, and measuring how much the material has slumped to determine if it meets a predetermined threshold. In the present embodiment, the liquid-phase reagent includes a polymer, such as a super absorbent polymer, mixed with an oil, such as a natural oil, vegetable oil, or similar hydrophobic viscous liquid to provide a flowable liquid. In the present embodiment, the polymer is generally configured to absorb water. However, in other embodiments, the polymer can be configured to absorb other fluids or bind with at least one component in the liquid waste. It is to be appreciated that the type of polymer and oil that are mixed as well as the ratios is not particularly limited and can be varied depending on a specific application. For example, the polymers, oils, and ratios can be modified and adjusted to optimize the liquid-phase reagent for a specific type of liquid waste depending on the type of earth 80 the tunnel boring machine 30 is drilling through. In addition, the viscosity of the liquid-phase reagent can be adjusted to allow for optimal flow. For example, the range of viscosities for the liquid-phase reagent may be as low as 100 cps or may be as high as 2000 cps depending on the specific application

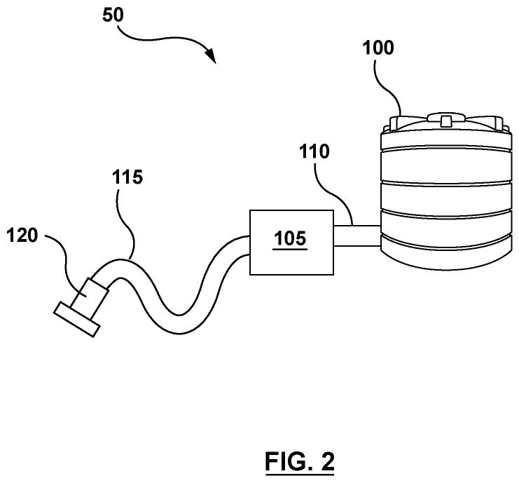

Referring to FIG. 2, an embodiment of the apparatus 50 for solidifying a liquid waste is shown in greater detail. It is to be understood that the apparatus 50 is purely exemplary and it will be apparent to those skilled in the art with the benefit of this description that a wide variety of modifications are contemplated including those discussed in greater detail below in connection with other embodiments. In the present embodiment, the apparatus 50 includes a tank 100, a pump 105, piping 110, and a delivery system 115.

In the present embodiment, the tank 100 is generally configured to store the liquid-phase reagent. It is to be understood that the tank 100 is not particularly limited to any specific type of tank and that several different designs, shapes, and materials are contemplated. Examples of materials that can be used for forming the tank 100 include plastic, steel, fiberglass, and aluminum. Furthermore, the tank 100 is not limited to any particular size and can vary depending on the application. For example, in the present embodiment of the tunnel boring operation 10, the tank can be typically about 1000 liters and include ports for the addition of liquid-phase reagent during operation without interrupting the operation of the apparatus 50. Furthermore, it is to be appreciated by a person of skill in the art with the benefit of this description that various valves can be used to control the flow of the liquid-phase reagent. In addition, some embodiments can include mechanisms for mixing the liquid-phase reagent in the tank, such as a mechanical mixer or a loop to cycle the liquid-phase reagent through the pump and back into the tank (not shown).

The pump 105 is connected to the tank 100 and generally configured to move the liquid-phase reagent from the tank and through the delivery system 115 proximate to the bore face. It is to be appreciated by a person of skill with the benefit of this description that the pump 105 is not particularly limited and that a wide variety of pumps can be used. For example, the present embodiment uses a progressive cavity pump. However, it is to be appreciated that other types of pumps can be used, such as a diaphragm pump. Furthermore, it is to be understood that the pump 105 can be modified or changed depending on the specific application, such as how much liquid-phase reagent is needed to be delivered, or the viscosity of the liquid-phase reagent.

The manner by which the pump 105 is controlled is not particularly limited. In the present embodiment, the pump 105 can be manually switched by a user to be on and the flow rate controlled using valves. In other embodiments, the pump 105 can be controlled using an electronic controller, such as a variable frequency drive, to provide a more consistent and reliable flow rate. In such embodiments, it is to be appreciated that the electronic controller can be calibrated such that a relatively precise amount of liquid-phase reagent is delivered.

In some embodiments, optional sensors can be used to monitor the flow of liquid-phase reagent through the delivery system and the electronic controller can use the sensor input to optimize the flow of liquid-phase reagent through the delivery system to achieve optimal solidification.

In the present embodiment, the piping 110 connects the tank 100 to the pump 105. The piping 110 is not particularly limited and can include any type of piping capable of withstanding the pressures of the liquid-phase reagent. It is to be appreciated by a person of skill in the art that the piping 110 is optional and not necessary. For example, in other embodiments, the pump 105 can be connected directly to the tank 100. In other embodiments, the pump 105 can be submerged within the tank 100.

The delivery system 115 is generally configured to deliver the liquid-phase reagent proximate to the bore face in the present embodiment. The delivery system 115 is not particularly limited and can include a high-pressure hose, piping or other structures capable of delivering a fluid from the pump 105 to a desired work location. In the present embodiment, the delivery system 115 includes a hose for delivering liquid-phase reagent to the appropriate area near the tunnel boring machine 30. The end of the delivery system 115 can include a connector, such as a flange 120 for dispensing the liquid-phase reagent to the tunnel boring machine 30. It is to be appreciated that in this embodiment, the apparatus 50 is independent of the tunnel boring machine 30 and can be added onto a wide variety of tunnel boring machines without requiring significant modifications. In other embodiments, it is to be appreciated that the flange 120 may be replaced with another type of connector or a nozzle for manual application of the liquid-phase reagent.

Referring back to FIG. 1, the tunnel boring operation 10 is carried out to bore a tunnel through earth 80. As the tunnel boring machine 30 grinds earth and rock away at the bore face, liquid waste is generated at the bore face and collecting generally at the bottom of the tunnel. Liquid-phase reagent is delivered to the cutting surface near the auger 35 or at the bottom end of the auger 35. Immediately upon mixing the liquid-phase reagent with the liquid waste, the mixture remains in liquid form moving up the auger 35. As the liquid-phase reagent and the liquid waste move up the auger 35, they react causing solidification of the mixture into the solid waste 85. It is to be appreciated that the auger 35 in the present embodiment also provides additional mixing of the liquid-phase reagent and the liquid waste as it is moved through the auger 35. The solid waste 85 exits the auger 35 onto the conveyor belt 40 for subsequent removal from the tunnel to a surface containment or vehicle 90 to remove from the boring operation 10. It is to be appreciated by a person of skill in the art that the solid waste 85 may not be completely solid at the exit of the auger 35 in some embodiments. In such embodiments, the solid waste 85 may continue to solidify after exiting the auger 35 and while travelling on the conveyor belt 40 or even after exiting the tunnel.

It is to be re-emphasized that the apparatus 50 described above is a schematic, non-limiting representation only and that variations are contemplated. As an example of a variation, the pump 105 can be omitted in some embodiments. For example, in some embodiments, compressed air can be injected in to the apparatus 50 to push the liquid-phase reagent through the delivery system. In other embodiments, the tank 10 can be pressurized, or gravity can be used to cause the liquid-phase reagent to flow.

Furthermore, the method of using the apparatus 50 is also not particularly limited and the apparatus 50 can be used in a variety of other applications calling for the solidification of a liquid.

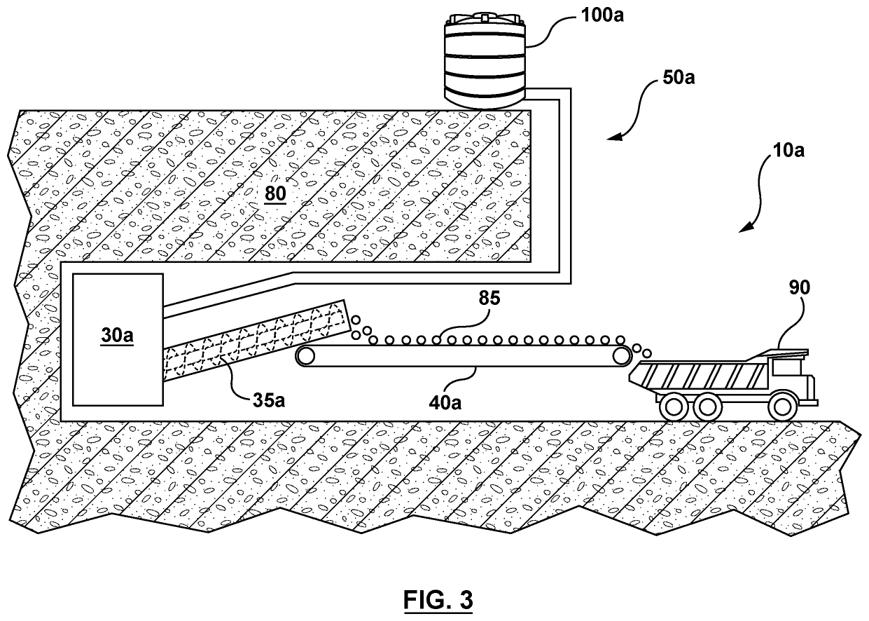

Referring to FIG. 3, another embodiment showing the application of an apparatus 50a for solidifying a liquid in a tunnel boring operation is generally shown at 10a. In the present embodiment, like components of the apparatus 50a bear like reference to their counterparts in the apparatus 50, except followed by the suffix “a”. In the present embodiment, the apparatus 50a is generally located away from the tunnel boring machine 30a and includes piping to deliver the liquid-phase reagent proximate to the end of the auger 35a from outside the tunnel. It is to be appreciated by a person of skill in the art that such an embodiment can allow for easier servicing of the apparatus (such as for loading liquid-phase reagent).

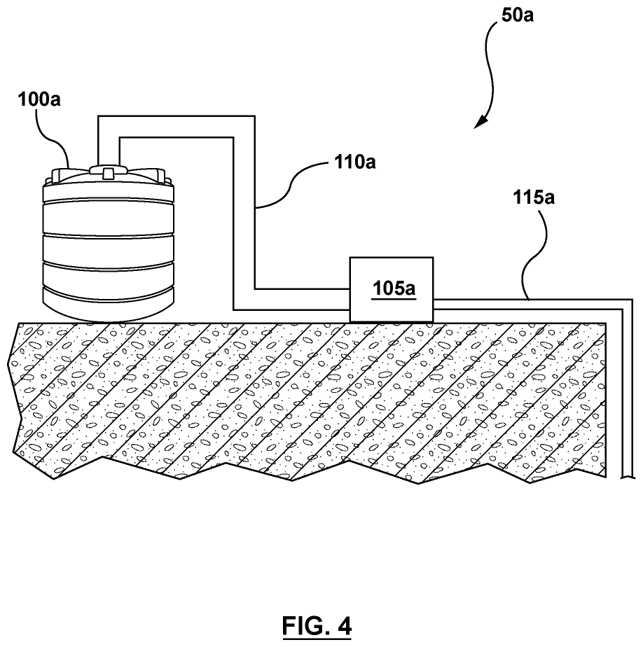

Referring to FIG. 4, the apparatus 50a for solidifying a liquid waste is shown in greater detail. In the present embodiment, the apparatus 50a includes a tank 100a, a pump 105a, piping 110a, and a delivery system 115a.

The delivery system 115a is generally configured to deliver the liquid-phase reagent to the bore face from the exterior of the tunnel. The delivery system 115a is not particularly limited and can include a high-pressure hose, piping or other structures capable of delivering a fluid from the pump 105a to a desired work location. In the present embodiment, the delivery system 115a can be modified during operation to accommodate for the moving bore face relative to the tank 100a. The end of the delivery system 115a can include a coupling for coupling with the tunnel boring machine 30a which can include internal liquid-phase reagent dispensing capabilities. Alternatively, the end of the delivery system 115a can include an optional nozzle similar to the nozzle 120 discussed above for dispensing the liquid-phase reagent to the work area. It is to be appreciated that in this embodiment, the delivery system 115a is independent of the tunnel boring machine 30a and can be used in combination to a wide variety of tunnel boring machines without requiring additional modifications.

It is to be appreciated by a person of skill in the art with the benefit of this description, that the apparatus 50 may be further varied. For example, the pump 105a may not be a separate unit as shown in FIG. 4 and instead be disposed on the tank 100a, or within the tunnel boring machine 30a.

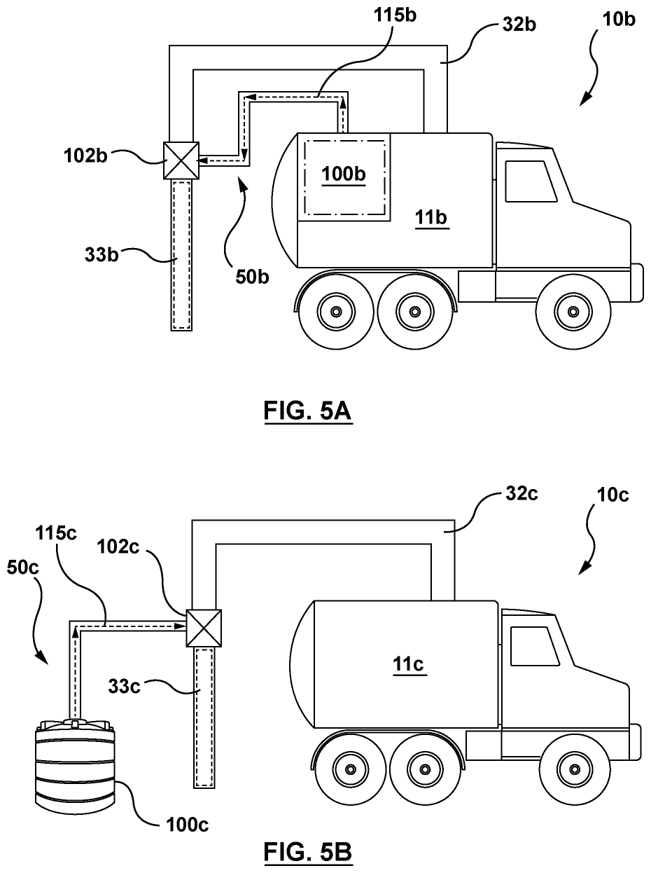

Referring to FIG. 5A, another embodiment showing the application of an apparatus 50b for solidifying a liquid/soil mixture in a vacuum truck is generally shown at 10b. The vacuum truck 10b may be used for an excavation process or other application involving the removal of liquid waste, such as earth mixed with groundwater. In the present embodiment, like components of the apparatus 50b bear like reference to their counterparts in the apparatus 50, except followed by the suffix “b”. For example, the apparatus 50b includes a tank 100b, and a delivery system 115b. It is to be appreciated that the vacuum truck 10b is not particularly limited and can be substituted with other types of trucks for collecting liquids such as a hydro excavation (“hydrovac”) truck. In the present example, the vacuum truck 10b includes a tubing system, which may include a rigid tube 32b, connected to a containment tank 11b into which the material is drawn into by the vacuum system (not shown). At the other end of the rigid tube 32b, a vacuum inlet pipe 33b is mounted to provide movement of the vacuum inlet at the location from which material is to be drawn. In the present example, the vacuum inlet pipe 33b is a flexible pipe that may be manipulated by an operator to provide a limited range of motion without having to reposition the truck 10b or moving the rigid tube 32b.

It is to be appreciated by a person of skill in the art with the benefit of this description that the operation of the apparatus 50b is substantially similar to the apparatus 50. In the present embodiment, the apparatus 50b includes a tank 100b and a delivery system 115b connected to an injection point 102b of the truck 10b. The injection point 102b is not limited and is generally in communication with the liquid waste being collected such that the injection point 102b provides access to the liquid waste for the liquid-phase reagent. In the present example, the injection point 102b is positioned between the rigid tube 32b and the vacuum inlet pipe 33b. In other examples, the injection point 102b may be positioned at other locations.

The manner by which the delivery system 115b is connected at the injection point 102b is not particularly limited. For example, the delivery system 115b can be connected to the injection point 102b using a union joint. Since the truck 10b creates a suction through the tube 32b and the vacuum inlet pipe 33b, the delivery system 115b can simply be connected to the injection point 102b and allow the negative pressure and/or the Venturi effect to draw the liquid-phase reagent from the tank 100b through the delivery system 115b. In other embodiments, the apparatus 50b can include a pump and/or valves to better control the flow of the liquid-phase reagent.

In operation, a vacuum truck 10b sucks liquid waste through the vacuum inlet pipe 33b. At the injection point 102b, the delivery system 115b delivers a liquid-phase reagent to cause solidification. As the liquid waste travels from the vacuum inlet pipe 33b to the tube 32b and onwards to a containment tank 11b of the vacuum truck 10b, the turbulence would provide for additional mixing. Once inside the vacuum truck 10b, the liquid waste is solidified and can be removed from the vacuum truck 10b for shipping via another vehicle such as a dump truck, which is more economical than driving to a location where the vacuum truck 10b is to be emptied.

Referring to FIG. 5B, another embodiment showing the application of an apparatus 50c for solidifying a liquid in a vacuum truck is generally shown at 10c. In the present embodiment, like components of the apparatus 50c bear like reference to their counterparts in the apparatus 50b, except followed by the suffix “c”. For example, the apparatus 50c includes a tank 100c, and a delivery system 115c. In the present example, the vacuum truck 10c includes a tubing system, which may include a rigid tube 32c, connected to a containment tank 11c into which the material is drawn into by the vacuum system (not shown). At the other end of the rigid tube 32c, a vacuum inlet pipe 33c is mounted to provide movement of the vacuum inlet at the location from which material is to be drawn. In the present embodiment, the apparatus 50c is substantially similar to the apparatus 50b with the exception that the apparatus 50c is separate from the vacuum truck. In this embodiment, the apparatus 50c may be mounted on a trailer or be a separate stand-alone unit transported to the work site. It is to be appreciated with the benefit of this description that this embodiment allows for the use of the apparatus 50c with multiple vacuum trucks and would not require any significant modifications to the vacuum truck 10c. Accordingly, in some applications, the apparatus 50c may be placed at a work site where multiple vacuum trucks are brought to the location to remove material from the worksite and connected to each vacuum truck during operation. In the present embodiment, the apparatus 50c includes a tank 100c and a delivery system 115c for connecting to an injection point 102c of the truck 10c. In the present example, the injection point 102c is positioned between the rigid tube 32c and the vacuum inlet pipe 33c. In other examples, the injection point 102c may be positioned at other locations.

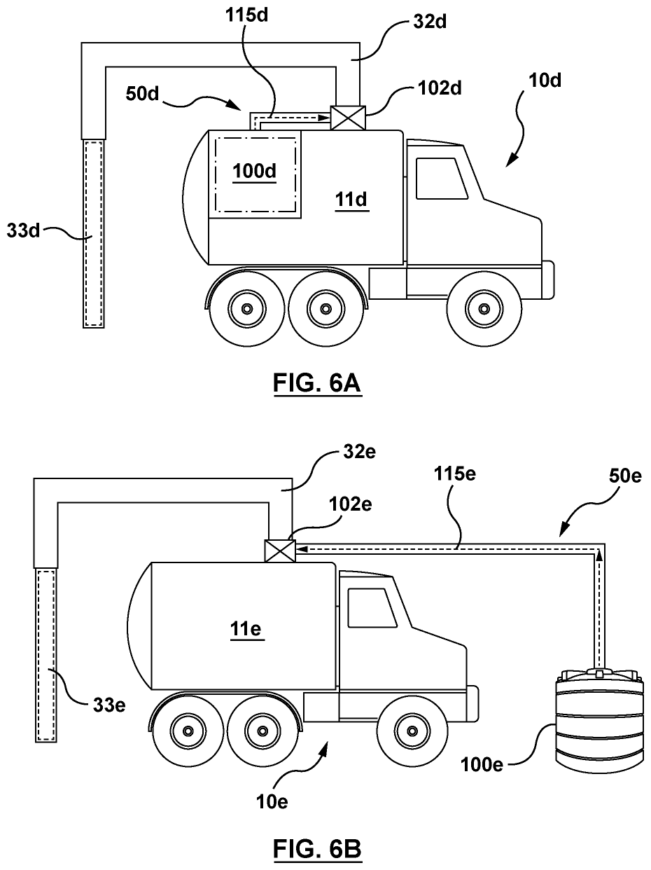

Referring to FIG. 6A, another embodiment showing the application of an apparatus 50d for solidifying a liquid in a vacuum truck is generally shown at 10d. In the present embodiment, like components of the apparatus 50d bear like reference to their counterparts in the apparatus 50, except followed by the suffix “d”. For example, the apparatus 50d includes a tank 100d, and a delivery system 115d. In the present example, the vacuum truck 10d includes a tubing system, which may include a rigid tube 32d, connected to a containment tank 11d into which the material is drawn into by the vacuum system (not shown). At the other end of the rigid tube 32d, a vacuum inlet pipe 33d is mounted to provide movement of the vacuum inlet at the location from which material is to be drawn. In the present example, the vacuum inlet pipe 33d is a flexible pipe that may be manipulated by an operator to provide a limited range of motion without having to reposition the truck 10d or moving the rigid tube 32d.

In the present embodiment, the delivery system 115d connects to an injection point 102d of the truck 10d. In the present example, the injection point 102d is positioned between the rigid tube 32d the containment tank 11d of the truck 10d. Accordingly, this configuration allows that apparatus 50d to include a shorter delivery system 115d.

In operation, a vacuum truck 10d draws liquid waste through the vacuum inlet pipe 33d and through the tube 32d. At the injection point 102d, the delivery system 115d delivers a liquid-phase reagent to cause solidification. As the liquid waste enters the containment tank 11d of the vacuum truck 10d, the turbulence provides for mixing of the liquid-phase reagent with the liquid waste. Further mixing may be achieved using mixers (not shown) inside the containment tank 11d or through natural agitation caused by the movement of the vacuum truck 10d as it moves to an unloading location. Once the liquid waste is solidified and can be removed from the vacuum truck 10d for shipping via another vehicle such as a dump truck, which is more economical than driving to a location where the vacuum truck 10d is to be emptied.

Referring to FIG. 6B, another embodiment showing the application of an apparatus 50e for solidifying a liquid in a vacuum truck is generally shown at 10e. In the present embodiment, like components of the apparatus 50e bear like reference to their counterparts in the apparatus 50d, except followed by the suffix “e”. For example, the apparatus 50e includes a tank 100e, and a delivery system 115e. In the present example, the vacuum truck 10e includes a tubing system, which may include a rigid tube 32e, connected to a containment tank 11e into which the material is drawn into by the vacuum system (not shown). At the other end of the rigid tube 32e, a vacuum inlet pipe 33e is mounted to provide movement of the vacuum inlet at the location from which material is to be drawn.

In the present embodiment, the apparatus 50e is substantially similar to the apparatus 50d with the exception that the apparatus 50e is separate from the vacuum truck. In this embodiment, the apparatus 50e may be mounted on a trailer or be a separate stand-alone unit transported to the work site. It is to be appreciated with the benefit of this description that this embodiment allows for the use of the apparatus 50e with multiple vacuum trucks and would not require any significant modifications to the vacuum truck 10e. Accordingly, in some applications, the apparatus 50e may be placed at a work site where multiple vacuum trucks are brought to the location to remove material from the worksite and connected to each vacuum truck during operation. In the present embodiment, the apparatus 50e includes a tank 100e and a delivery system 115e for connecting to an injection point 102e of the truck 10e. In the present example, the injection point 102e is positioned between the rigid tube 32e and the containment tank 11e of the vacuum truck 10e.

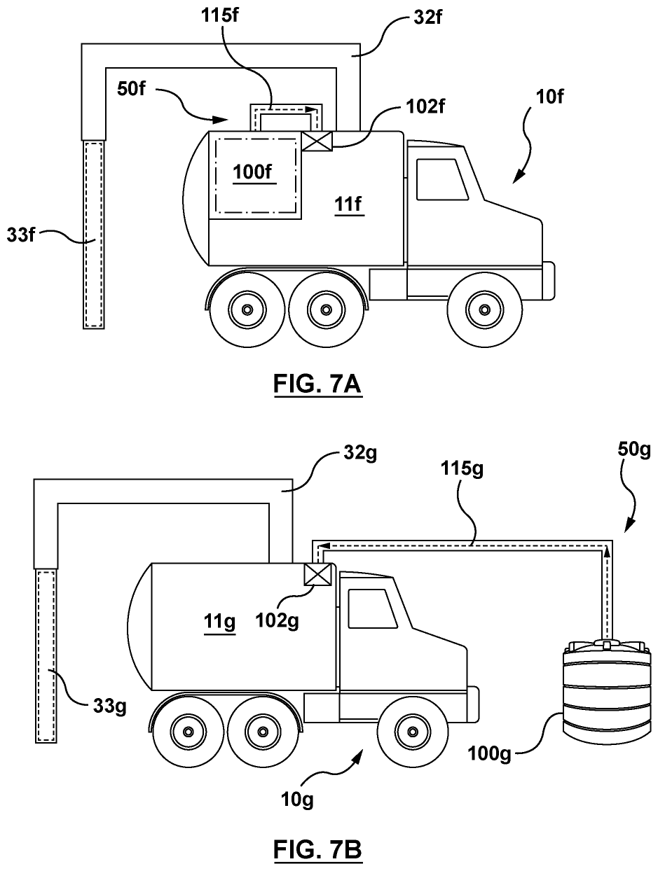

Referring to FIG. 7A, another embodiment showing the application of an apparatus 50f for solidifying a liquid in a vacuum truck is generally shown at 10f. In the present embodiment, like components of the apparatus 50f bear like reference to their counterparts in the apparatus 50, except followed by the suffix “f”. For example, the apparatus 50f includes a tank 100f, and a delivery system 115f. n the present example, the vacuum truck 10f includes a tubing system, which may include a rigid tube 32f, connected to a containment tank 11f into which the material is drawn into by the vacuum system (not shown). At the other end of the rigid tube 32f, a vacuum inlet pipe 33f is mounted to provide movement of the vacuum inlet at the location from which material is to be drawn. In the present example, the vacuum inlet pipe 33f is a flexible pipe that may be manipulated by an operator to provide a limited range of motion without having to reposition the truck 10f or moving the rigid tube 32f.

In the present embodiment, the delivery system 115f connects to an injection point 102f of the truck 10f. In the present example, the injection point 102f is positioned between the containment tank 11f of the truck 10f. Accordingly, the liquid-phase reagent is added directly into the containment tank 11f of the truck 10f after the liquid waste has been added. It is to be appreciated by a person of skill in the art with the benefit of this description, that by adding the liquid-phase reagent to directly to the containment tank 11f, more accurate dosing can be obtained.

In operation, a vacuum truck 10f draws liquid waste through the vacuum inlet pipe 33f and through the tube 32f. At the injection point 102f, the delivery system 115f delivers a liquid-phase reagent to cause solidification in the containment tank 11f of the vacuum truck 10f. It is to be appreciated that mixing may be achieved using mixers inside the containment tank 11f or through natural agitation caused by the movement of the vacuum truck 10f as it moves to an unloading location. Once the liquid waste is solidified and can be removed from the vacuum truck 10f for shipping via another vehicle such as a dump truck, which is more economical than driving to a location where the vacuum truck 10f is to be emptied.

Referring to FIG. 7B, another embodiment showing the application of an apparatus 50g for solidifying a liquid in a vacuum truck is generally shown at 10g. In the present embodiment, like components of the apparatus 50e bear like reference to their counterparts in the apparatus 50f, except followed by the suffix “e”. For example, the apparatus 50g includes a tank 100g, and a delivery system 115g. In the present example, the vacuum truck 10g includes a tubing system, which may include a rigid tube 32g, connected to a containment tank 11g into which the material is drawn into by the vacuum system (not shown). At the other end of the rigid tube 32g, a vacuum inlet pipe 33g is mounted to provide movement of the vacuum inlet at the location from which material is to be drawn.

In the present embodiment, the apparatus 50g is substantially similar to the apparatus 50f with the exception that the apparatus 50g is separate from the vacuum truck. In this embodiment, the apparatus 50g may be mounted on a trailer or be a separate stand-alone unit transported to the work site. It is to be appreciated with the benefit of this description that this embodiment allows for the use of the apparatus 50g with multiple vacuum trucks and would not require any significant modifications to the vacuum truck 10g. Accordingly, in some applications, the apparatus 50g may be placed at a work site where multiple vacuum trucks are brought to the location to remove material from the worksite and connected to each vacuum truck during operation. In the present embodiment, the apparatus 50g includes a tank 100g and a delivery system 115g for connecting to an injection point 102g of the truck 10g.

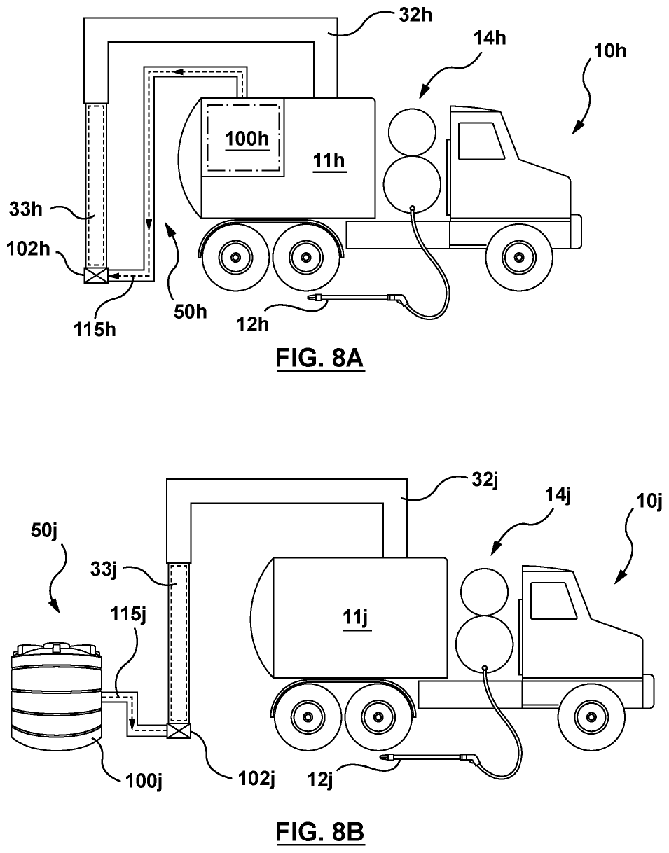

Referring to FIG. 8A, another embodiment showing the application of an apparatus 50h for solidifying a liquid in a hydrovac truck is generally shown at 10h. In the present embodiment, like components of the apparatus 50h bear like reference to their counterparts in the apparatus 50, except followed by the suffix “h”. For example, the apparatus 50h includes a tank 100h, and a delivery system 115h. In the present example, the hydrovac truck 10h includes a tubing system, which may include a rigid tube 32h, connected to a containment tank 11h into which the material is drawn into by the vacuum system (not shown). At the other end of the rigid tube 32h, a vacuum inlet pipe 33h is mounted to provide movement of the vacuum inlet at the location from which material is to be drawn. In the present example, the vacuum inlet pipe 33h is a flexible pipe that may be manipulated by an operator to provide a limited range of motion without having to reposition the truck 10h or moving the rigid tube 32h. Furthermore, the hydrovac truck 10h includes a pressurized water system 14h for providing pressurized water via a wand 12h.

The pressurized water system 14h is not particularly limited and may include a variety of systems capable of providing water. For example, the pressurized water system 14h may include a pump to draw water from a water tank and dispense the water at high-pressure. Alternatively, the tanks may be simply stored at high-pressure such that the pressurized water system 14h does not need a separate pump in order to reduce weight on the hydrovac truck 10h. The wand 12h is also not limited and is generally a handheld wand to allow for an operator to inject high-pressure water from the pressurized water system 14h into the ground during the excavation process. Accordingly, as water is injected into the ground, waste generated during a hydrovac process would include a substantial amount of liquid waste.

In the present embodiment, the delivery system 115h connects to an injection point 102h of the truck 10h. In the present example, the injection point 102h is positioned at the end of the vacuum inlet pipe 33h. Accordingly, this configuration allows liquid-phase reagent to be added to the liquid waste earlier in the process to allow for more time to mix and solidify prior to entering the containment tank 11h of the hydrovac truck 10h as solid waste.

In operation, a hydrovac truck 10h draws liquid waste through the vacuum inlet pipe 33h and through the tube 32h. At the injection point 102h, the delivery system 115h delivers a liquid-phase reagent to cause solidification of the soil and water mixture. As the liquid waste enters the vacuum inlet pipe 33h, the turbulence along the path to the containment tank 11h through the tube 32h provides for mixing of the liquid-phase reagent with the liquid waste. Once the liquid waste is solidified and can be removed from the hydrovac truck 10d for shipping via another vehicle such as a dump truck, which is more economical than driving to a location where the liquid and soil mixture in the hydrovac truck 10d is to be emptied.

Referring to FIG. 8B, another embodiment showing the application of an apparatus 50j for solidifying a liquid in a hydrovac truck is generally shown at 10j. In the present embodiment, like components of the apparatus 50j bear like reference to their counterparts in the apparatus 50h, except followed by the suffix “j”. For example, the apparatus 50j includes a tank 100j, and a delivery system 115j. In the present example, the hydrovac truck 10j includes a tubing system, which may include a rigid tube 32j, connected to a containment tank 11j into which the material is drawn into by the vacuum system (not shown). At the other end of the rigid tube 32j, a vacuum inlet pipe 33j is mounted to provide movement of the vacuum inlet at the location from which material is to be drawn.

In the present embodiment, the apparatus 50j is substantially similar to the apparatus 50h with the exception that the apparatus 50j is separate from the hydrovac truck 10j. In this embodiment, the apparatus 50j may be mounted on a trailer or be a separate stand-alone unit transported to the work site. It is to be appreciated with the benefit of this description that this embodiment allows for the use of the apparatus 50j with multiple vacuum trucks and would not require any significant modifications to the hydrovac truck 10j. Accordingly, in some applications, the apparatus 50j may be placed at a work site where multiple hydrovac trucks are brought to the location to remove material from the worksite and connected to each vacuum truck during operation. In the present embodiment, the apparatus 50j includes a tank 100j and a delivery system 115j for connecting to an injection point 102j of the truck 10j. In the present example, the injection point 102j is positioned between the rigid tube 32j and the containment tank 11j of the hydrovac truck 10j.

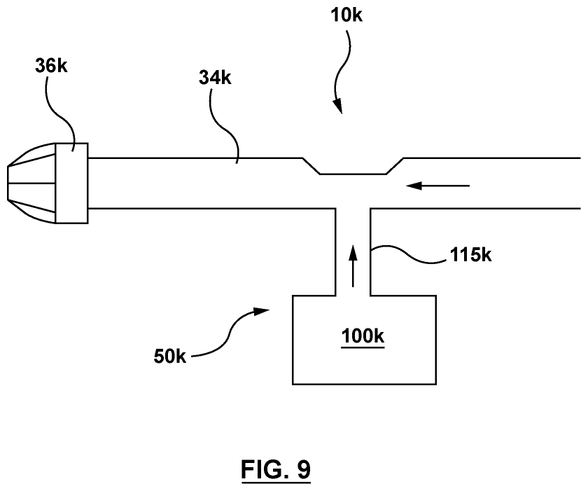

Referring to FIG. 9, another embodiment showing the application of an apparatus 50k for solidifying a liquid in a water spray gun is generally shown at 10k. In the present embodiment, like components of the apparatus 50k bear like reference to their counterparts in the apparatus 50, except followed by the suffix “k”. For example, the apparatus 50k includes a tank 100k, and a delivery system 115k.

It is to be appreciated to a person of skill in the art with the benefit of this description that the operation of the apparatus 50k is substantially similar to the apparatus 50b. In the present embodiment, the apparatus 50k includes only a tank 100k and a delivery system 115k connected to the tube 34k of the water spray gun 10k. The manner by which the delivery system 115k is connected to the tube 34k is not particularly limited. For example, the delivery system 115k can be connected to the tube 34k using a similar mechanism that are used to connect a pesticide sprayer to a garden hose or a soap dispenser on a high-pressure washer. Since the water spray gun 10k creates a suction through the tube 34k as the water passes over the delivery system 115k, the delivery system 115k can simply be connected to the tube 34k and allow the Venturi effect to draw the liquid-phase reagent from the tank 100k through the delivery system 115k. Accordingly, liquid and liquid-phase reagent are mixed in the tube 34k and exit through the nozzle 36k. It is to be appreciated by a person of skill in the art with the benefit of this description that although the liquid-phase reagent would solidify the high-pressure water in the tube 34k, the water is still ejected in a liquid form from the nozzle 36k prior to solidification. In other embodiments, the apparatus 50k can include a pump and/or valves to better control the flow of the liquid-phase reagent. In further embodiments, the apparatus 50k can be incorporated into smaller scale applications such as a handheld sprayer with a pumping mechanism. For example, the liquid-phase reagent can be dispensed from a backpack or a cart for solidifying relatively small amounts of liquid waste. In yet another embodiment, the apparatus 50k may be modified such that the delivery system 115k may deliver the liquid-phase reagent separated from the nozzle, such as in a parallel stream.

In operation, a water spray gun 10k delivers high-pressure water through the tube 34k. The high-pressure water can be used to break ground in some applications and thus generate mud and liquid waste. Near the opening of the tube 34k, the delivery system 115k delivers a liquid-phase reagent to cause solidification. The liquid waste and liquid-phase reagent can then be cleaned up relatively quickly, for example, by using a vacuum truck. Alternatively, the liquid waste can be cleaned up after solidification has occurred to generate a loose sand-like material.

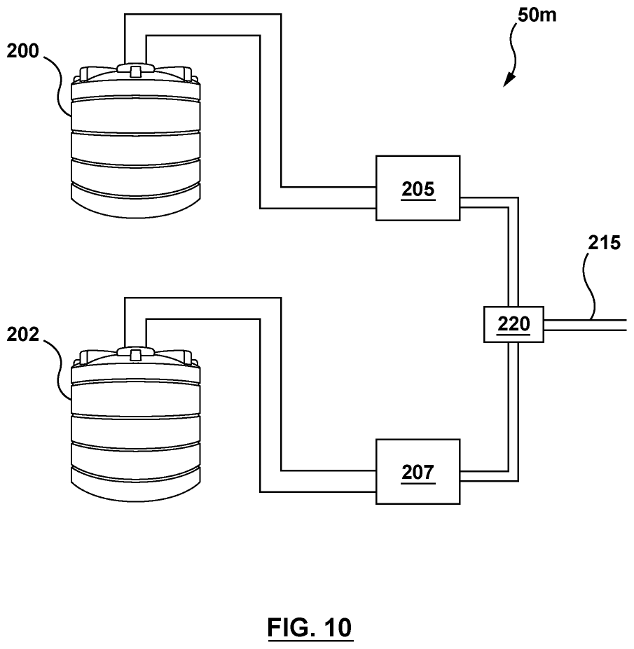

Referring to FIG. 10, another embodiment of the apparatus 50m for solidifying a liquid waste is generally shown. It is to be understood that the apparatus 50m is purely exemplary and it will be apparent to those skilled in the art with the benefit of this description that the apparatus 50m can be used to substitute any one of the apparatus previously described. In the present embodiment, the apparatus 50m includes a fluid tank 200, a polymer tank 202, pumps 205 and 207, a delivery system 215, and a mixer 220. In the present embodiment, the fluid in the fluid tank 200 is an oil configured to hold the polymer from the polymer tank 202 in suspension. However, in other embodiments involving other liquid-phase reagents, the fluid tank 200 can hold a solvent or other type of fluid capable of carrying the polymer. Furthermore, in embodiments where the polymer in the polymer tank 202 is a dry powder, it is to be appreciated that the pump 207 can be substituted with a suitable dispensing system.

It is to be appreciated by a person of skill in the art that the apparatus 50m allows for better control of the composition of the liquid-phase reagent and can provide adjustments by varying ratio of fluid from the fluid tank 200 and the polymer from the polymer tank 202. Therefore, the present embodiment allows for quick modifications to accommodate changes in the application. In the tunnel boring operation 10 discussed above, the tunnel boring machine 30 can encounter different materials as it advances through the earth 80, for example, it can pass from sediment to bedrock material. When changing materials, the boring operation may generate different liquid waste that would be solidified better using a different composition.

It is to be re-emphasized that the structures described herein are non-limiting representations only. In particular, it is to be understood that various features of the embodiments described herein can be combined or modified. For example, it is to be appreciated by a person of skill in the art with the benefit of this description that the components of the above described apparatus can be modified, combined, and substituted with each other. In addition, each of the above described apparatus can be used in other applications.

As an example of a variation, the system 50 can be modified and used to replace a dry powder reagent delivery system. As another example, the system 50 can also be applied to a submersible pump in tanks of liquid waste.

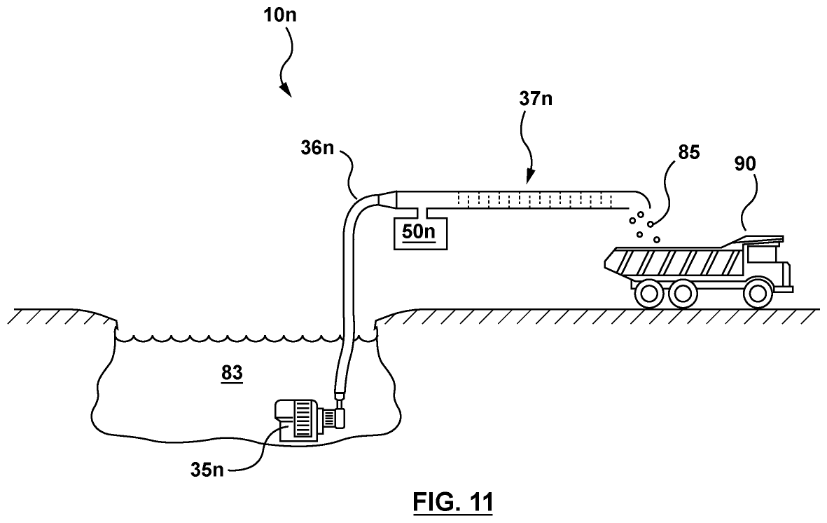

As another example of a variation, a schematic representation of an operation for removing liquid waste 83 from a holding pond is generally shown at 10n in FIG. 11. In the present embodiment, the operation includes a submersible pump 35n for pumping the liquid waste 83 from a holding pond through a tube 36n. An apparatus 50m for solidifying the liquid waste can inject a liquid-phase reagent into the tube 36n for solidifying the liquid waste 83 into solid waste 85 for loading into the vehicle 90. It is to be appreciated that the vehicle is not particularly limited. In the present embodiment, the vehicle 90 is a dump truck. However, the vehicle can be modified to be any type of vehicle capable of transporting a solid. Furthermore, in other embodiments, the vehicle 90 can be substituted with a tank, bin, pit, or other manner of storing solid waste 85. It is to be appreciated that in such embodiments, the liquid waste 83 can be converted to solid waste 85 and stored until a vehicle is available to remove the solid waste 85 from the site.

In the present embodiment, the tube 36n is generally configured to transport waste from the holding pond to the vehicle 90 for removal from the site altogether. In addition, the tube 36n receives a liquid-phase reagent from the apparatus 50m for converting liquid waste 83 into solid waste. In the present embodiment, the tube 36n includes baffles 37n to enhance mixing of the liquid waste 83 with the liquid-phase reagent from the apparatus 50m. In other embodiments, the baffles 37n can be modified or substituted with another mechanism to enhance mixing, such as an auger. In further embodiments, the baffles 37n can be omitted if the liquid waste 83 and the liquid-phase reagent can sufficiently mix within the tube 36n without any additional enhancements.

It is to be appreciated by a person of skill in the art with the benefit of this description that the manner by which material is moved through the tube 36n is not particularly limited. For example, in the present embodiment, the submersible pump 35n can provide sufficient pressure to push the contents through the tube 36n even after solidification. In other embodiments, additional pumps can be installed along the length of the tube 36n to assist in moving material through the tube 36n. In further embodiments, a vacuum system can also be used to pull the solid waste 85 out of the tube 36n.

It is to be re-emphasized that the operation shown at 10n is a non-limiting representation only and that variations are contemplated. As an example of a variation, the submersible pump 35n can be substituted with another type of pump such as a pump on the surface capable of sucking the liquid waste 83 out of the holding pond and into the tube 36n. As another example of a variation, optional mechanisms for purging the tube as well as sensors for monitoring the flow of material through the tube can be added. Furthermore, and additional optional valve can be added to the end of the tube 36n to allow for repositioning of the vehicle 90 or pausing the flow of solid waste 85.

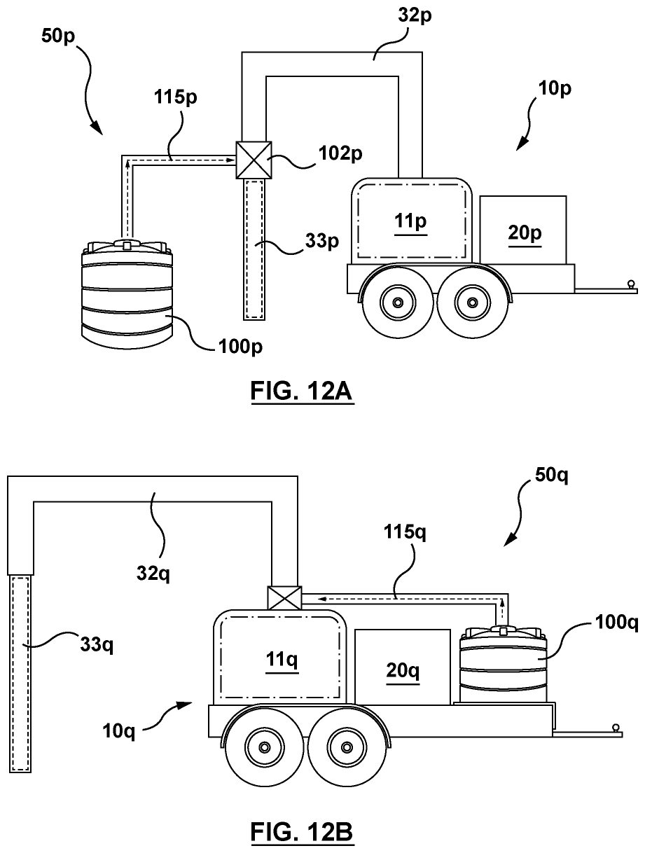

Referring to FIG. 12A, another embodiment showing the application of an apparatus 50p for solidifying a liquid in a vacuum trailer is generally shown at 10p. In the present embodiment, like components of the apparatus 50p bear like reference to their counterparts in the apparatus 50, except followed by the suffix “p”. It is to be appreciated that the present example is similar to the vacuum truck 10c, except for the vacuum components being placed on a trailer 10p for portability instead of on a stand-alone truck. For example, the apparatus 50p includes a tank 100p, and a delivery system 115p. It is to be appreciated that the vacuum trailer 10p is not particularly limited and can be any type of trailer capable of hauling the vacuum system and containment tank 11p.

In the present example, the vacuum trailer 10p includes a tubing system, which may include a rigid tube 32p, connected to a containment tank 11p into which the material is drawn into by the vacuum system 20p. At the other end of the rigid tube 32p, a vacuum inlet pipe 33p is mounted to provide movement of the vacuum inlet at the location from which material is to be drawn. In the present example, the vacuum inlet pipe 33p is a flexible pipe that may be manipulated by an operator to provide a limited range of motion without having to reposition the trailer 10p or moving the rigid tube 32p.

In this embodiment, the apparatus 50p may be mounted on a separate trailer or be a separate stand-alone unit transported to the work site. It is to be appreciated with the benefit of this description that this embodiment allows for the use of the apparatus 50p with multiple vacuum trailers and would not require any significant modifications to the vacuum trailer 10p. Accordingly, in some applications, the apparatus 50p may be placed at a work site where multiple vacuum trailers are brought to the location to remove material from the worksite and connected to each vacuum trailer during operation. In the present embodiment, the apparatus 50p includes an injection point 102p to receive liquid-phase reagent between the rigid tube 32p and the vacuum inlet pipe 33p.

In the present embodiment, the apparatus 50p includes only a tank 100p and a delivery system 115p connected to the tube 32p, an injection point 102p of the vacuum trailer 10p. In the present example, the injection point 102p is positioned between the rigid tube 32p and the vacuum inlet pipe 33p. In other examples, the injection point 102p may be positioned at other locations.

The manner by which the delivery system 115p is connected to the tube 32p at the injection point 102p is not particularly limited. For example, the delivery system 115p can be connected to the injection point 102p the tube 32p using a union joint. Since the trailer 10p creates a suction through the tube 32p and the vacuum inlet pipe 33p, the delivery system 115p can simply be connected to the injection point 102p tube 32p and allow the negative pressure and/or the Venturi effect to draw the liquid-phase reagent from the tank 100p through the delivery system 115p. In other embodiments, the apparatus 50p can include a pump and/or valves to better control the flow of the liquid-phase reagent.

In operation, a vacuum trailer 10p sucks liquid waste into through the tube 32p, the vacuum inlet pipe 33p. At the injection point 102p, the delivery system 115p delivers a liquid-phase reagent to cause solidification. As the liquid waste travels through from the vacuum inlet pipe 33p to the tube 32p and into onwards to a containment tank 11p of the vacuum trailer 10p, the turbulence would provide for additional mixing. Once inside the vacuum trailer 10p, the liquid waste is solidified and can be removed from the vacuum trailer 10p for shipping via another vehicle such as a dump truck.

Referring to FIG. 12B, another embodiment showing the application of an apparatus 50q for solidifying a liquid in a vacuum trailer is generally shown at 10q. In the present embodiment, like components of the apparatus 50q bear like reference to their counterparts in the apparatus 50, except followed by the suffix “q”. For example, the apparatus 50q includes a tank 100q, and a delivery system 115q. In the present example, the vacuum trailer 10q includes a tubing system, which may include a rigid tube 32q, connected to a containment tank 11q into which the material is drawn into by the vacuum system 20q. At the other end of the rigid tube 32q, a vacuum inlet pipe 33q is mounted to provide movement of the vacuum inlet at the location from which material is to be drawn. In the present example, the vacuum inlet pipe 33q is a flexible pipe that may be manipulated by an operator to provide a limited range of motion without having to reposition the trailer 10q or moving the rigid tube 32q.

In the present embodiment, the delivery system 115q connects to an injection point 102q of the trailer 10q. In the present example, the injection point 102q is positioned between the rigid tube 32q and the containment tank 11q of the trailer 10q. Accordingly, this configuration allows that apparatus 50q to include a shorter delivery system 115q.

In operation, a vacuum trailer 10q draws liquid waste through the vacuum inlet pipe 33q and through the tube 32q. At the injection point 102q, the delivery system 115q delivers a liquid-phase reagent to cause solidification. As the liquid waste enters the containment tank 11q of the vacuum trailer 10q, the turbulence provides for mixing of the liquid-phase reagent with the liquid waste. Further mixing may be achieved using mixers inside the containment tank 11q or through natural agitation caused by the movement of the vacuum trailer 10q as it moves to an unloading location. Once the liquid waste is solidified and can be removed from the vacuum trailer 10q for shipping via another vehicle such as a dump truck.

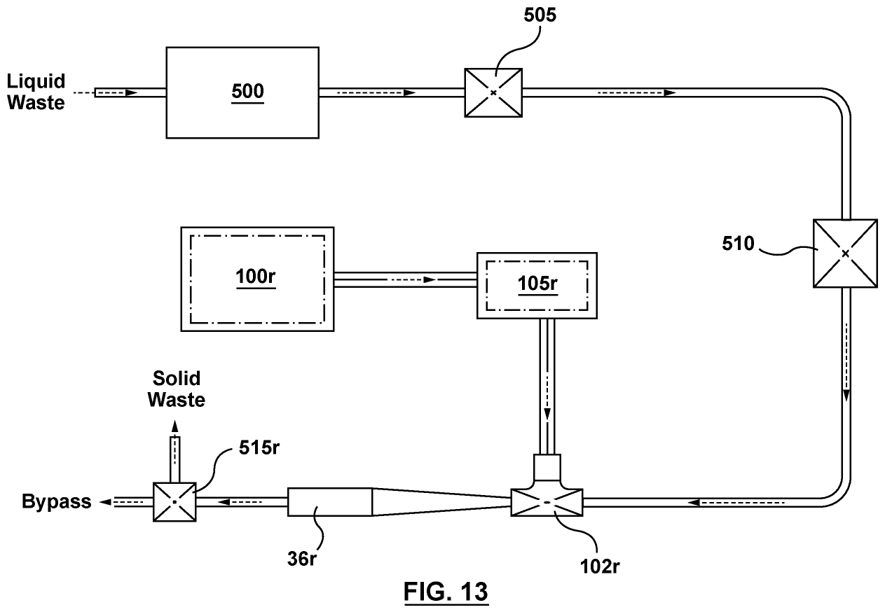

Referring to FIG. 13, another embodiment showing the application of an apparatus 50r for solidifying a liquid in a general system is shown at 10r. It is to be appreciated that the system 10r may be installed in a variety of applications including the applications discussed above. For example, the apparatus 10r may be used in a tunnel boring application, integrated on a vacuum truck/trailer, or for removing liquid waste from a holding pond. The system 10r includes a filtration system 500, a pump 505, a flow meter 510 an injection point 102r, a mixing component 36r and a valve 515.

The filtration system 500 is not particularly limited and is used to filter the liquid waste collected by the system 10r. In the present embodiment, the filtration system 500 may be any course filtration system, such as a shaker table. For example, the filtration system 500 may be used to remove particles larger than about 0.25 inches. In another example, the filtration system 500 may be used to remove particles larger than about 0.50 inches. It is to be appreciated that in other the filtration system may be used to screen for dimensions depending on the specific application and/or downstream equipment.

It is to be appreciated by a person of skill with the benefit of this description that the pump 505 is not particularly limited and that a wide variety of pumps can be used depending on the specific application. For example, in a vacuum truck example, the pump 505 may be the vacuum pump of the truck. However, it is to be appreciated that other types of pumps can be used, especially in larger scale operations such as removal of liquid waste from a holding pond. Accordingly, the pump 505 may be any type of pump capable of drawing in liquid waste to the system 10r. It is to be appreciated that in some embodiments, such as when the liquid waste to be solidified is placed in an elevated container such as a hopper, the pump 505 may be omitted if other forces (such as gravity) can push the liquid waste through the system 10r.

Similarly, the flow meter 510 is not particularly limited and is to measure the amount of liquid waste flowing through the system 10r. The amount of liquid waste flowing through the system 10r may be used to determine dosing of the liquid-phase reagent. It is to be appreciated that the flow meter 510 is optional and may be omitted in other embodiments.

In the present embodiment, the apparatus 50r includes a tank 100r and a delivery system 115r connected to an injection point 102r. At the injection point 102r, the delivery system delivers a liquid-phase reagent to cause solidification via a pump 105r. As the liquid waste passes through the injection point 102r, the liquid waste mixes with the injected liquid-phase reagent and the turbulence provides for mixing. In addition, an additional high shear mixing component 36r may be used to further promote mixing of the liquid waste and the liquid-phase reagent to promote solidification. In the present embodiment, the high shear mixing component 36r passes liquid through a jetting nozzle to increase the velocity of the liquid using multiple shear mixing components. This process effectively increases the turbulence within the liquid material (the first shear mixing component). Subsequently, the liquid material passes into a Venturi system to decelerate the liquid material, causing additional turbulence as well as a pressure drop (the second shear mixing component). The liquid material passes through a perforated tube designed to promote the material passing through the holes in order to shear the liquid material and cause further turbulence (the third shear mixing component).

The apparatus 10r further includes a valve 515 to direct the flow of liquid waste. In the present embodiment, the valve is a 3-way valve. In this example, the apparatus may be used as a simple pumping system to allow for liquid waste to be moved through the system 10r without adding the liquid-phase reagent. Accordingly, this operation is similar to a vacuum system. To operate the apparatus 10r in this state, the injection point 10r would be shut down and the 3-way valve would be set the fluid to flow straight through. To solidify waste, the injection point 102r may be opened and the 3-way valve may direct the solid waste to another containment tank for removal.

Various advantages will now be apparent to a person of skill in the art. Of note is the ability to solidify liquid waste at the source of the liquid waste. It is to be understood that the apparatus 50 by solidifying the liquid waste, removed and subsequent handling of the solid waste becomes more economical.

While specific embodiments have been described and illustrated, such embodiments should be considered illustrative only and should not serve to limit the accompanying claims.

What is claimed is:

1. A vehicle for removing waste material from a worksite, the vehicle comprising:
a containment tank to store the waste material;
a vacuum inlet pipe in communication with the containment tank, wherein the vacuum inlet pipe is to draw the waste material from the worksite and to deliver the waste material to the containment tank;
a reagent tank to store a liquid-phase reagent, wherein the liquid-phase reagent is a polymer suspension in an oil, the polymer to solidify the waste material; and
an injection point to receive the liquid-phase reagent, wherein the injection point provides access to the liquid waste; and
a delivery system to deliver the liquid-phase reagent to injection point.

2. The vehicle of claim 1, wherein the vacuum inlet pipe is a flexible pipe be manipulated by an operator.

3. The vehicle of claim 1, further comprising a rigid tube to connect the vacuum inlet pipe to the containment tank.

4. The vehicle of claim 3, wherein the injection point is disposed between the vacuum inlet pipe and the rigid tube.

5. The vehicle of claim 3, wherein the injection point is disposed on the containment tank.

6. The vehicle of claim 1, further comprising a pressurized water system to provide pressurized water.

7. The vehicle of claim 6, further comprising a wand to dispense high-pressure water from the pressurized water system to break up ground material to generate waste material.

8. The vehicle of claim 1, wherein the vehicle is a truck.

9. The vehicle of claim 1, wherein the vehicle is a trailer.

10. A method of removing waste material from a worksite, the method comprising:
drawing the waste material from the worksite via a vacuum inlet pipe;
delivering a liquid-phase reagent to an injection point, wherein the liquid-phase reagent is a polymer suspension in an oil, the polymer to solidify the waste material;
adding the liquid-phase reagent to the waste material at the at the injection point to solidify the waste material;
delivering the waste material to a containment tank; and
storing the solidified waste material in the containment tank.

11. The method of claim 10, wherein delivering the waste material to a containment tank comprises using a rigid tube, wherein the rigid tub connects the vacuum inlet pipe to the containment tank.

12. The method of claim 11, wherein delivering a liquid-phase reagent comprises delivering the liquid-phase reagent between the vacuum inlet pipe and the rigid tube.

13. The method of claim 12, further comprising mixing the waste material and the liquid-phase reagent in the rigid tube.

14. The method of claim 10, wherein delivering a liquid-phase reagent comprises delivering the liquid-phase reagent to the containment tank.

15. The method of claim 14, further comprising mixing the waste material and the liquid-phase reagent in the containment tank.

16. The method of claim 10, further comprising dispensing high-pressure water from a pressurized water system to break up ground material to generate waste material.

16. The method of claim 16, wherein dispensing the high-pressure water comprises dispensing the high-pressure water via a wand.

17. A system for solidifying waste material from a worksite, the system comprising:
a liquid-phase reagent source to provide a liquid-phase reagent, wherein the liquid-phase reagent is a polymer suspension in an oil, the polymer to solidify the waste material;
a delivery system to deliver the liquid-phase reagent to the waste material; and
a connector to connect the delivery system to waste removal system, wherein the waste removal system is to collect the waste material.

18. The system of claim 17, further comprising a pump to move the liquid-phase reagent through the delivery system.

19. The system of claim 16, wherein liquid-phase reagent source comprises:
a polymer tank to store the polymer in a powder form;
a fluid tank to store the oil; and
a mixer connected to the polymer tank and the fluid tank, wherein the mixer is to combine the polymer and the oil to produce the polymer suspension.

20. The system of claim 19, further comprising:
a polymer dispenser to dispense the polymer to the mixer; and
a fluid tank pump to dispense the oil from the fluid tank to the mixer.
